(19) United States
(12) Patent Application Publication
(10) Pub. No.: US 2019/0040281 A1
(43) Pub. Date: Feb. 7, 2019

(54) System and Method for Forming an Adhesion Promoter

(71) Applicant: Darkside Scientific, Inc., Medina, OH (US)

(72) Inventors: Steve Galayda, Lodi, OH (US); Shawn J. Mastrian, Austin, TX (US)

(21) Appl. No.: 15/666,783

(22) Filed: Aug. 2, 2017

(51) Int. Cl. C09J 5/00; C09J 109/00; C09J 183/00; C09J 175/04; C09J 109/06; C09J 133/08; C09J 123/08; C09J 11/06; C09J 181/04; B05D 1/02

(52) U.S. Cl. CPC C09J 5/00; C09J 109/00; C09J 183/00; C09J 175/04; B05D 1/02; C09J 133/08; C09J 123/0853; C09J 11/06; C09J 181/04; C09J 109/06

(57) ABSTRACT

The subject technology relates to an adhesion promoter that is applied to a surface for the purpose of adhesion and/or to facilitate application of various spray applied conformal coatings.

### BACKGROUND AND SUMMARY

The present invention relates to methods and formulations useful for adhesion and pre-treatment of surfaces to facilitate spray applied coatings.

Some surfaces (e.g. glass) are not well suited for application of spray applied coatings. Such coatings do not adhere, or stick, to such surfaces. There is therefore a need for methods and formulations that facilitate preparation of such surfaces. The invention described herein solves the foregoing problem and additionally offers other objects and advantages that will be apparent to those of skill in the art.

In some aspects, the subject technology is applied using a high pressure, low volume, spray technique, wherein the constituents are atomized by compressed air and deposited on a substrate. In some aspects, the subject technology is applied using an aerosol spray technique wherein the constituents are atomized by a propellant and deposited on a substrate.

In some aspects, the subject technology comprises an elastomeric polymer component, film-forming binder component, and reducer solvent component. In other aspects, the subject technology comprises an elastomeric polymer component, film-forming binder component, polyurethane binder component, isocyanate component, and reducer solvent component.

### BRIEF DESCRIPTION OF THE DRAWINGS

FIG. 1 depicts a cross-sectional illustration of an adhesive film layer applied to a first object according to one aspect of the subject technology

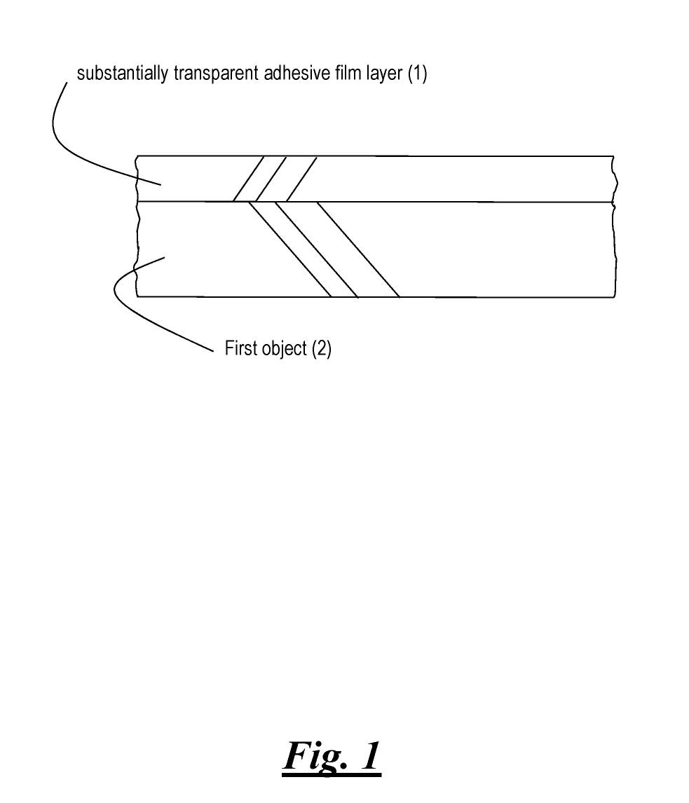

FIG. 2 depicts a cross-sectional illustration of an adhesive film layer applied to a first object which is then adhered to a second object, according to one aspect of the subject technology.

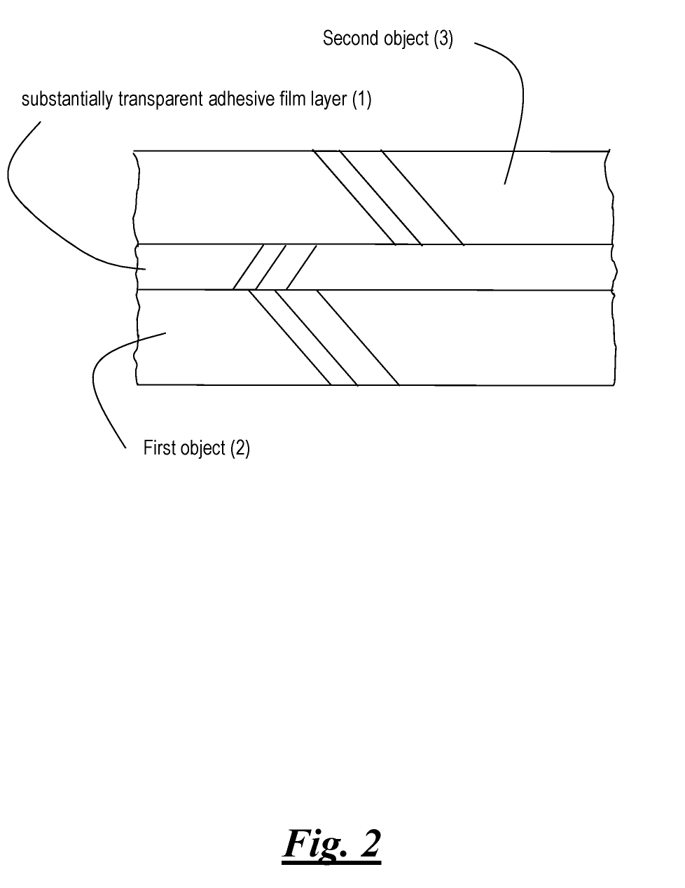

### DETAILED DESCRIPTION

Various objects (aka substrates) can be coated with the subject technology (aka adhesion promoter), including plastic, metal, Teflon, wood, ceramic, glass, concrete, cement, solid foam, rubber, elastomeric, so as to form a cohesive and adhesive film 1 thereon. The coated first object 2 can then be adhered to a second object 3. Alternatively, the film 1 can be cured for a period of 10 minutes to 24 hours. Thereafter, the film can be painted with any acrylic, latex, urethane, silicone, or acetate based paint which adheres to the adhesion promoter and in effect coats the object in a painted film.

In one aspect, a substantially transparent adhesive film layer 1 for use in a spray-applied conformal coating of a first object 2, comprises an elastomeric polymer component; a film-forming binder component; and a reducer solvent component.

In one aspect, a substantially transparent adhesive film layer 1 for use in a spray-applied conformal coating of a first object 2, comprises substantially 10-20% by weight of an elastomeric polymer component; substantially 2-8% by weight of a film-forming binder component; and substantially 70-85% by weight of a reducer solvent component.

In one aspect, the film-forming binder component includes any one or more of: an acrylic, polyurethane, vinyl, latex, cellulose acetate butyrate. In one aspect, the elastomeric polymer component is selected from the family of: polyisoprene, silicone, polyurethane, polysulfide, styrene-butadiene rubber (SBR), butyl, acrylic or polyacrylate, isoprene, polyisobutylene, ethylene-vinyl acetate (EVA), and vinyl and nitrile compounds.

In one aspect, the substantially transparent adhesive film layer comprises substantially 13-17% by weight of the elastomeric polymer component. In one aspect, the substantially transparent adhesive film layer comprises substantially 3% by weight of the film-forming binder component. In one aspect, the film-forming binder component includes any one or more of: an acrylic, polyurethane, vinyl, latex, or cellulose acetate butyrate. In one aspect, the substantially transparent adhesive film layer comprises substantially 77-81% by weight of the reducer solvent component.

In one aspect, the reducer solvent component includes any one or more of: naptha, toluene, xylene, acetone, naphtha, mineral spirits, methyl ethyl ketone, acetone, water, ethanol, isopropyl alcohol, n-butyl alcohol, methanol, ethyl benzene, cumene, Solane, n-propyl acetate, methyl acetate, methyl cyclohexane, p-Trifluoromethylphenyl chloride, and p-Chlorobenzotrifluoride, or other volatile solvent. In one aspect, the reducer solvent component comprises: a ratio of substantially 20-25% by weight naptha, substantially 40-60% by weight methyl acetate, and substantially 25-45% by weight p-Chlorobenzotrifluoride.

In one aspect, a substantially transparent adhesive film layer 1 for use in a spray-applied conformal coating of a first object 2 comprises an elastomeric polymer component; a film-forming binder component; a polyurethane binder component; an isocyanate component; and a reducer solvent component.

In one aspect, a substantially transparent adhesive film layer 1 for use in a spray-applied conformal coating of a first object 2 comprises substantially 7-12% by weight of an elastomeric polymer component; substantially 1-4% by weight of a film-forming binder component; substantially 10-20% by weight of a polyurethane binder component; substantially 1-5% by weight of an isocyanate component; and substantially 70-85% by weight of a reducer solvent component.

In one aspect, the elastomeric polymer component is selected from the family of polyisoprene; silicone; polyurethane; polysulfide; styrene-butadiene rubber (SBR); butyl, acrylic or polyacrylate; isoprene; polyisobutylene; ethylene-vinyl acetate (EVA); and vinyl and nitrile compounds.

In one aspect, the substantially transparent adhesive film layer comprises substantially 8-10% by weight of the elastomeric polymer component.

In one aspect, the substantially transparent adhesive film layer comprises substantially 1.5% by weight of the film-forming binder component, substantially 15% by weight of the polyurethane binder component, and substantially 2.5% by weight of the isocyanate component.

In one aspect, the film-forming binder component includes any one or more of an acrylic, polyurethane, vinyl, latex, or cellulose acetate butyrate.

In one aspect, the substantially transparent adhesive film layer comprises substantially 77-81% by weight of the reducer solvent component.

In one aspect, the reducer solvent component includes any one or more of naptha, toluene, xylene, acetone, naphtha, mineral spirits, methyl ethyl ketone, acetone, water, ethanol, isopropyl alcohol, n-butyl alcohol, methanol, ethyl benzene, cumene, Solane, n-propyl acetate, methyl acetate, methyl cyclohexane, p-Trifluoromethylphenyl chloride, and p-Chlorobenzotrifluoride, or other volatile solvent.

In one aspect, the reducer solvent component further comprises a ratio of substantially 20-25% by weight naptha, substantially 40-60% by weight methyl acetate, and substantially 25-45% by weight p-Chlorobenzotrifluoride.

In the various aspects of the subject technology described herein, the reducer solvent component is functionally compatible with the film-forming binder component and elastomeric polymer component; the film-forming binder component is compatible with the elastomeric polymer component, such that it is able to mix homogenously and does not have an adverse reaction to the elastomeric polymer, such as causing it to gel, and forms a film that flows evenly and consistently when atomized onto the surface of an object. In the various aspects of the subject technology described herein, the reducer solvent component assists in the deposition and post-deposition flow of the subject technology.

The various aspects of the substantially transparent adhesive film layer as described herein can be applied to a first object 2 with a high pressure, low volume, spray technique, wherein each of the elastomeric polymer component, film-forming binder component, and reducer solvent component are atomized by compressed air and deposited on a substrate. The various aspects of the substantially transparent adhesive film layer as described herein can be applied to a first object 2 with a high pressure, low volume, spray technique, wherein each of the elastomeric polymer component, film-forming binder component, polyurethane binder component, isocyanate component, and reducer solvent component are atomized by compressed air and deposited on a substrate.

The various aspects of the substantially transparent adhesive film layer as described herein can be applied to a first object 2 with an aerosol spray technique, wherein each of the elastomeric polymer component, film-forming binder component, and reducer solvent component are atomized by a propellant inside of a can and deposited on a substrate. In one aspect, the propellant inside of the can comprises propane. The various aspects of the substantially transparent adhesive film layer as described herein can be applied to a first object 2 with an aerosol spray technique, wherein each of the elastomeric polymer component, film-forming binder component, polyurethane binder component, isocyanate component, and reducer solvent component are atomized by a propellant inside of a can and deposited on a substrate. In one aspect, the propellant inside of the can comprises propane.

What is claimed is:

1. A substantially transparent adhesive film layer for use in a spray-applied conformal coating, the substantially transparent adhesive film layer comprising:
an elastomeric polymer component;
a film-forming binder component being compatible with the elastomeric polymer component;
and a reducer solvent component;
said reducer solvent component being functionally compatible with the film-forming binder component and elastomeric polymer component.

2. A substantially transparent adhesive film layer for use in a spray-applied conformal coating, the substantially transparent adhesive film layer comprising:
10-20% by weight of an elastomeric polymer component;
2-8% by weight of a film-forming binder component being compatible with the elastomeric polymer component;
and 70-85% by weight of a reducer solvent component;
said reducer solvent component being functionally compatible with the film-forming binder component and elastomeric polymer component.

3. The substantially transparent adhesive film layer of claim 2 further comprising:
the elastomeric polymer component being selected from the family of polyisoprene, silicone, polyurethane, polysulfide, styrene-butadiene rubber (SBR), butyl, acrylic or polyacrylate, isoprene, polyisobutylene, ethylene-vinyl acetate (EVA), and vinyl and nitrile compounds.

4. The substantially transparent adhesive film layer of claim 2 further comprising:
13-17% by weight of the elastomeric polymer component.

5. The substantially transparent adhesive film layer of claim 2 further comprising:
3% by weight of the film-forming binder component.

6. The substantially transparent adhesive film layer of claim 2 further comprising:
said film-forming binder component including any one or more of
an acrylic, polyurethane, vinyl, latex, or cellulose acetate butyrate.

7. The substantially transparent adhesive film layer of claim 2 further comprising:
77-81% by weight of the reducer solvent component.

8. The substantially transparent adhesive film layer of claim 2 further comprising:
the reducer solvent component including any one or more of:
naptha, toluene, xylene, acetone, naphtha, mineral spirits, methyl ethyl ketone, acetone, water, ethanol, isopropyl alcohol, n-butyl alcohol, methanol, ethyl benzene, cumene, Solane, n-propyl acetate, methyl acetate, methyl cyclohexane, p-Trifluoromethylphenyl chloride, and p-Chlorobenzotrifluoride, or other volatile solvent.

9. The substantially transparent adhesive film layer of claim 8 wherein:
the reducer solvent component further comprises:
a ratio of 20-25% by weight naptha, 40-60% by weight methyl acetate, and 25-45% by weight p-Chlorobenzotrifluoride.

10. A method for applying a substantially transparent adhesive film layer comprising:
applying the substantially transparent adhesive film layer of claim 1 by
a high pressure, low volume, spray technique, wherein each of the elastomeric polymer component, film-forming binder component, and reducer solvent component are atomized by compressed air and deposited on a substrate.

11. A method for applying a substantially transparent adhesive film layer comprising:
applying the substantially transparent adhesive film layer of claim 1 by
an aerosol spray technique, wherein each of the elastomeric polymer component, film-forming binder component, and reducer solvent component are atomized by a propellant inside of a can and deposited on a substrate.

12. The method of claim 11 further comprising:
the propellant inside of the can comprises propane.

13. A method for coating an object in a painted film comprising:
forming a cohesive and adhesive film by applying the substantially transparent adhesive film layer of claim 1 to any plastic, metal, teflon, wood, ceramic, glass, concrete, cement, solid foam, rubber, elastomeric, or other surface;
curing the cohesive and adhesive film for a period of 10 minutes to 24 hours;
painting the cohesive and adhesive film with any acrylic, latex, urethane, silicone, or acetate based paint.

14. A substantially transparent adhesive film layer for use in a spray-applied conformal coating, the substantially transparent adhesive film layer comprising:
an elastomeric polymer component;
a film-forming binder component;
a polyurethane binder component;
an isocyanate component;
and a reducer solvent component;
said reducer solvent component being functionally compatible with the film-forming binder component and elastomeric polymer component.

15. A substantially transparent adhesive film layer for use in a spray-applied conformal coating, the substantially transparent adhesive film layer comprising:
7-12% by weight of an elastomeric polymer component;
1-4% by weight of a film-forming binder component;
10-20% by weight of a polyurethane binder component;
1-5% by weight of an isocyanate component;
and 70-85% by weight of a reducer solvent component;
said reducer solvent component being functionally compatible with the film-forming binder component and elastomeric polymer component.

16. The substantially transparent adhesive film layer of claim 15 further comprising:
the elastomeric polymer component being selected from the family of polyisoprene; silicone; polyurethane; polysulfide; styrene-butadiene rubber (SBR); butyl, acrylic or polyacrylate; isoprene; polyisobutylene; ethylene-vinyl acetate (EVA); and vinyl and nitrile compounds.

17. The substantially transparent adhesive film layer of claim 15 further comprising:
8-10% by weight of the elastomeric polymer component.

18. The substantially transparent adhesive film layer of claim 15 further comprising:
1.5% by weight of the film-forming binder component, 15% by weight of the polyurethane binder component, and 2.5% by weight of the isocyanate component.

19. The substantially transparent adhesive film layer of claim 15 further comprising:
said film-forming binder component including any one or more of
an acrylic, polyurethane, vinyl, latex, or cellulose acetate butyrate.

20. The substantially transparent adhesive film layer of claim 15 further comprising:
77-81% by weight of the reducer solvent component.

21. The substantially transparent adhesive film layer of claim 15 further comprising:
the reducer solvent component including any one or more of:
naptha, toluene, xylene, acetone, naphtha, mineral spirits, methyl ethyl ketone, acetone, water, ethanol, isopropyl alcohol, n-butyl alcohol, methanol, ethyl benzene, cumene, Solane, n-propyl acetate, methyl acetate, methyl cyclohexane, p-Trifluoromethylphenyl chloride, and p-Chlorobenzotrifluoride, or other volatile solvent.

22. The substantially transparent adhesive film layer of claim 21 wherein:
the reducer solvent component further comprises:
a ratio of 20-25% by weight naptha, 40-60% by weight methyl acetate, and 25-45% by weight p-Chlorobenzotrifluoride.

23. A method for applying a substantially transparent adhesive film layer comprising:
applying the substantially transparent adhesive film layer of claim 14 by
a high pressure, low volume, spray technique, wherein each of the elastomeric polymer component, film-forming binder component, polyurethane binder component, isocyanate component, and reducer solvent component are atomized by compressed air and deposited on a substrate.

24. A method for applying a substantially transparent adhesive film layer comprising:
applying the substantially transparent adhesive film layer of claim 14 by
an aerosol spray technique, wherein each of the elastomeric polymer component, film-forming binder component, polyurethane binder component, isocyanate component, and reducer solvent component are atomized by a propellant inside of a can and deposited on a substrate.

25. The method of claim 24 further comprising:
the propellant inside of the can comprises propane.

26. A method for coating an object in a painted film comprising:
forming a cohesive and adhesive film by applying the substantially transparent adhesive film layer of claim 14 to any plastic, metal, teflon, wood, ceramic, glass, concrete, cement, solid foam, rubber, elastomeric, or other surface;
curing the cohesive and adhesive film for a period of 10 minutes to 24 hours;
painting the cohesive and adhesive film with any acrylic, latex, urethane, silicone, or acetate based paint.

27. A method for joining two surfaces comprising:
applying the substantially transparent adhesive film layer of claim 1 to a first surface;
then joining the first surface to a second surface.

28. A method for joining two surfaces comprising:
applying the substantially transparent adhesive film layer of claim 14 to a first surface;
then joining the first surface to a second surface.
